(19) United States
(12) Patent Application Publication
(10) Pub. No.: US 2012/0170310 A1
(43) Pub. Date: Jul. 5, 2012

(54) LIGHT GUIDE WITH UNIFORM LIGHT DISTRIBUTION

(75) Inventors: Ion Bita, San Jose, CA (US); Lai Wang, Milpitas, CA (US); Kebin Li, Fremont, CA (US); Douglas Carl Burstedt, San Diego, CA (US); Yi-Fan Su, Hsin Chu County (TW)

(73) Assignee: QUALCOMM MEMS Technologies, Inc., San Diego, CA (US)

(21) Appl. No.: 13/279,158

(22) Filed: Oct. 21, 2011

Related U.S. Application Data
(60) Provisional application No. 61/430,096, filed on Jan. 5, 2011.

(51) Int. Cl. F21V 7/04; B23P 17/04; F21V 8/00

(52) U.S. Cl. 362/606; 362/613; 362/609; 29/592

(57) ABSTRACT

This disclosure provides systems, methods and apparatus for providing illumination by using a light guide to distribute light. In one aspect, the light guide has a light input edge into which light is injected and transverse edges transverse to the light input edge. The transverse edges are smooth and act as specular reflectors. The light input edge is rough and provides a diffusive interface. The light emitters are adjacent and centered along the light input edge, with the pitch of the light emitters being about ΔL, where ΔL is the distance between the transverse edges divided by the number of light emitters. The light guide can be provided with light turning features that redirect light out of the light guide. In some implementations, the redirected light can be applied to illuminate a display.

### REFERENCE TO RELATED APPLICATION

This application claims the priority benefit under 35 U.S.C. §119(e) of U.S. provisional Application No. 61/430,096, filed Jan. 5, 2011, entitled “LIGHT GUIDE WITH UNIFORM LIGHT DISTRIBUTION,” which is assigned to the assignee hereof. The disclosure of the prior application is considered part of this disclosure and is incorporated herein by reference in its entirety.

### TECHNICAL FIELD

This disclosure relates to illumination devices, including illumination devices for displays, particularly illumination devices having light guides, and to electromechanical systems.

### DESCRIPTION OF THE RELATED TECHNOLOGY

Electromechanical systems include devices having electrical and mechanical elements, actuators, transducers, sensors, optical components (e.g., minors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a metallic membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Reflected ambient light is used to form images in some display devices, such as those using pixels formed by interferometric modulators. The perceived brightness of these displays depends upon the amount of light that is reflected towards a viewer. In low ambient light conditions, light from an artificial light source is used to illuminate the reflective pixels, which then reflect the light towards a viewer to generate an image. To meet market demands and design criteria, new illumination devices are continually being developed to meet the needs of display devices, including reflective and transmissive displays.

### SUMMARY

The systems, methods and devices of the disclosure each have several innovative aspects, no single one of which is solely responsible for the desirable attributes disclosed herein.

One innovative aspect of the subject matter described in this disclosure can be implemented in an illumination system. The illumination system includes a plurality of light emitters and a light guide. The light guide includes a light input edge for receiving light from the plurality of light emitters and a first laser-cut edge transverse to the light input edge. The light input edge can be frosted and can have a surface roughness Ra of about 0.1-5 μm. The plurality of light emitters can be spread along the light input edge and have a pitch of about ΔL, where

$$Δ L = \frac{{L}_{light guide}}{{N}_{light emitters}}$$

where
ΔL is a distance between identical points of neighboring light emitters;
L_{light guide} is the distance between the transverse edges of the light guide; and
   N_{light emitters} is the number of light emitters in the plurality of light Emitters.
      In some implementations, the light emitters are centered along the light input edge.

Another innovative aspect of the subject matter described in this disclosure can be implemented in another illumination system that includes a light emitter, a light guide formed of glass, and a specular reflector along the transverse edge. The light guide includes a light input edge for receiving light from the light emitter and a transverse edge transverse to the light input edge. In some implementations, the specular reflector can be a surface of the transverse edge. In addition or alternatively, a specular reflector can be attached to the transverse edge. The specular reflector can be spaced apart from the transverse edge in some implementations.

Yet another innovative aspect of the subject matter described in this disclosure can be implemented in a display system. The display system includes a light guide having a light input edge, a first specular reflection surface, a display, and a plurality of spaced-apart light emitters. The light input edge of the light guide has a length; and a first transverse edge, the first transverse edge transverse to the light input edge. This first specular reflection surface is along the first transverse edge. The display has an active area, in which a major surface of the display faces a major surface of the light guide and the length of the light input edge is larger than a corresponding dimension of the pixel area in alignment with the length. The corresponding dimension may face the light of the light input edge. A spacing between the light emitters is about ΔL, where

$$Δ L = \frac{{L}_{light guide}}{{N}_{light emitters}}$$

where
ΔL is a distance between identical points of neighboring light emitters;
L_{light guide} is the distance separating the transverse edges of the light guide; and
N_{light emitters} is the number of light emitters in the plurality of light emitters.
   The plurality of light emitters may be centered along the length of the light input edge.

Another innovative aspect of the subject matter described in this disclosure can be implemented in an illumination system. The illumination system includes a means for emitting light; a light guide having a light input edge facing the light emitting means and opposing transverse edges transverse to the light input edge; and means for reflecting light along at least one of the transverse edges method.

Yet another innovative aspect of the subject matter described in this disclosure can be implemented in a method for manufacturing an illumination system. The method includes providing a light guide having an optical edge that is a specular reflector; and providing a light emitter at a light input edge of the light guide.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example of a top-down view of a light guide that can promote an uneven light distribution.

FIG. 9B shows an example of a photograph of a top-down view of a light guide with an uneven light distribution.

FIG. 10A shows a photograph of an example of a light guide edge formed by cutting with a diamond wheel.

FIG. 10B shows an example of a photograph of a top-down view of a section of the light guide also shown in FIG. 10A.

FIG. 11 shows an example of a photograph of a top-down view of the entirety of the light guide of FIG. 10B along with a plot of the light intensity on one side of the light guide.

FIG. 12 shows an example of a top-down view of an illumination system having a light guide with a smooth transverse edge.

FIG. 13A shows an example of a photograph of an edge of a light guide formed by laser-cutting.

FIG. 13B shows an example of a photograph of a top down view of a section of the light guide also shown in FIG. 13A.

FIG. 14A shows an example of a light guide having multiple light emitter arrays.

FIG. 14B shows an example of a side cross-section of display system incorporating the light guide of FIG. 14A.

FIG. 15 is an example of a photograph of top-down view of a light guide having light emitters spaced in accordance with some implementations.

FIG. 16 are examples of photographs showing a light guide without and with optically diffusive light input edges.

FIG. 17A shows an example of a side view of a display system with auxiliary reflectors spaced apart from a light guide by an air gap.

FIG. 17B shows an example of a side view of a display system with auxiliary reflectors spaced apart from a light guide by a layer of solid material.

FIG. 18A shows an example of a cross-section of a display system with an auxiliary reflector attached to a superstrate.

FIG. 18B shows an example of a cross-section of a display system with an auxiliary reflector attached to a light guide.

FIG. 19 a block diagram depicting an example of a method of manufacturing an illumination system.

FIGS. 20A and 20B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

In some implementations, an illumination system is provided with a light guide to distribute light. In one aspect, the light guide has a first light input edge into which light is injected, and transverse edges transverse to the first light input edge. One or both of the transverse edges are smooth and act as specular reflectors and/or can have an attached specular reflector to reflect light impinging on one or both of the transverse edges. The first light input edge can be rough, thereby providing a diffusive interface with an array of adjacent light emitters. The light emitters are uniformly spaced and centered along the first light input edge, with the pitch of the light emitters being about ΔL, where ΔL is equal to the distance between the transverse edges of the light guide divided by the number of light emitters. The light guide can be disposed in a stack with a display having a display area. The length covered by the light emitter array can extend pass the display area of the display. A second light input edge with its own diffusive surface can be disposed on a side of the light guide opposite the first light input edge, with a second plurality of light emitters centered and uniformly spaced along the second light input edge.

The light emitters inject light into the light guide through the light input edge. The light guide can be provided with light turning features that redirect the light out of the light guide. In some implementations, the redirected light can be applied to illuminate a display. In certain implementations, the display is a reflective display underlying the light guide.

Particular implementations of the subject matter described in this disclosure can be implemented to realize one or more of the following potential advantages. The diffusive light input edge can diffuse light entering into the light guide, thereby increasing the uniformity of light distribution within the light guide, particularly in regions close to the light input edge. As light propagates through the light guide, the specular reflections at the transverse edges provide light reflections with few artifacts and the reflections can also act as virtual light sources, which can further facilitate the uniform distribution of light within the light guide, particularly in regions farther from the light input edge. In addition, the spacing and placement of the light emitters can help to reduce or eliminate non-uniformities at the corners of the light guide and a dark “X”-shaped pattern across the light guide. The greater uniformity of light distribution within the light guide can increase the uniformity of light ejected from the light guide to illuminate an object, such as a display. Thus, highly uniform illumination of a display may be achieved in some implementations.

One example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

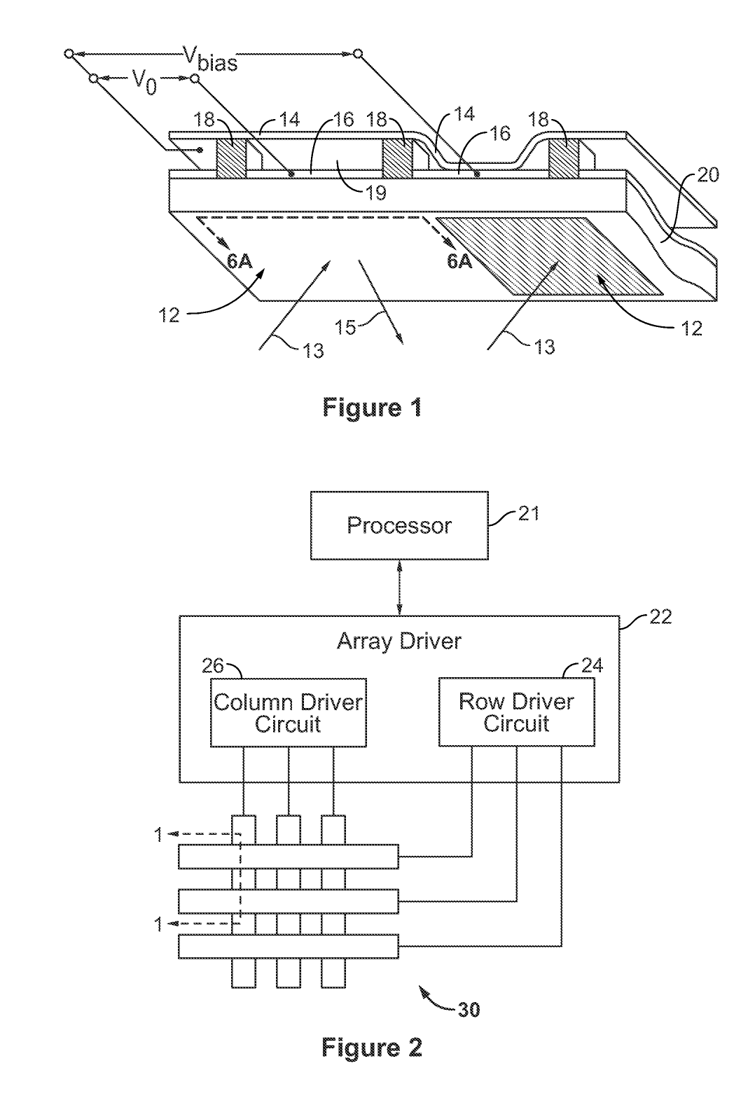

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14a remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

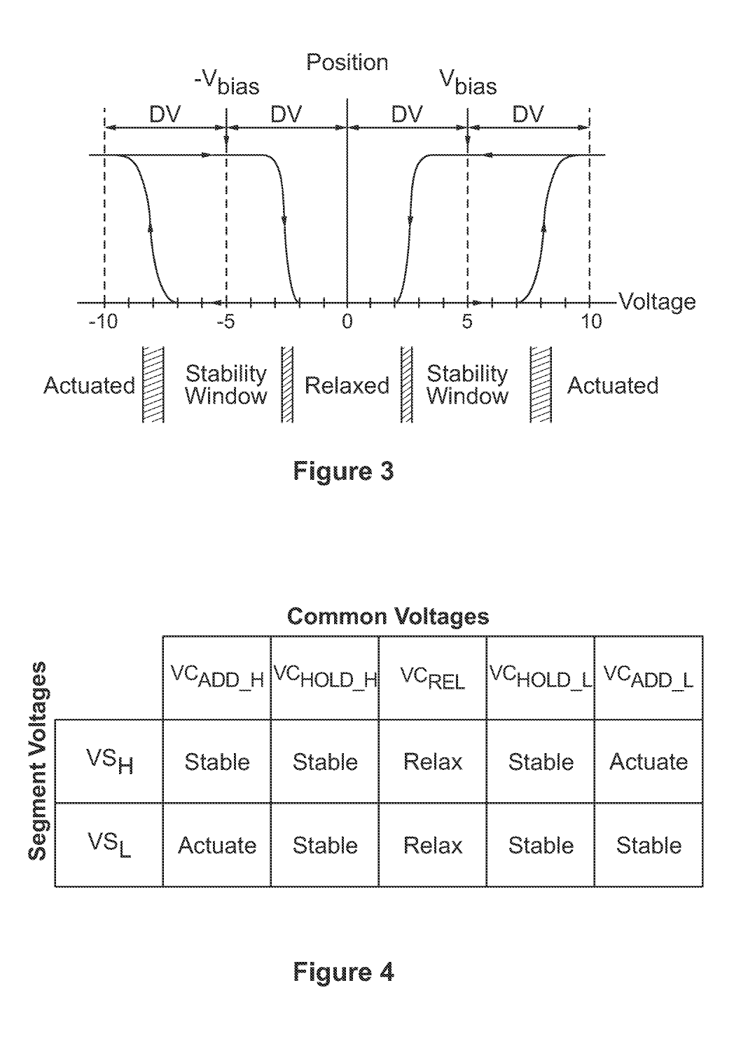

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or minor, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

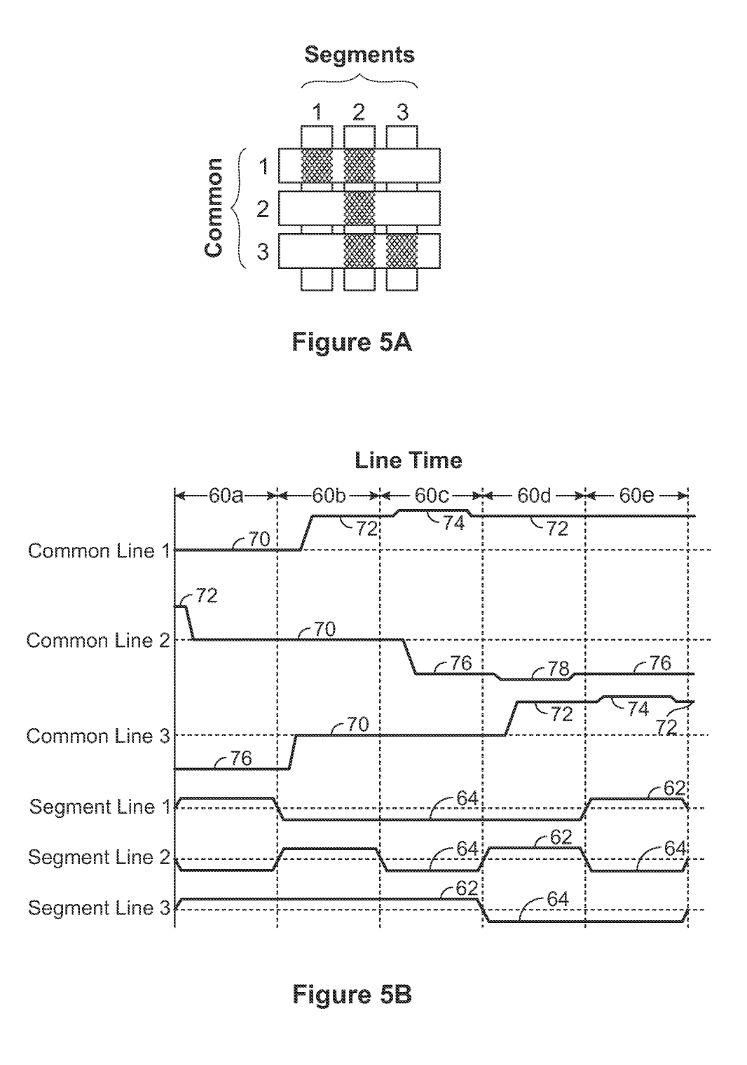

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

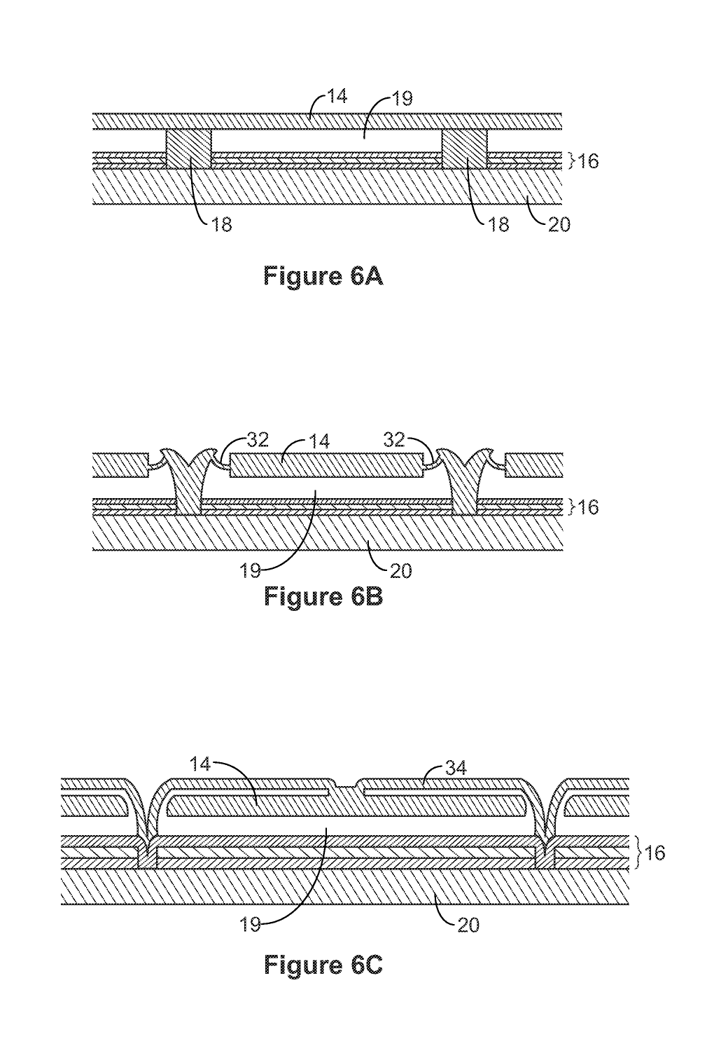

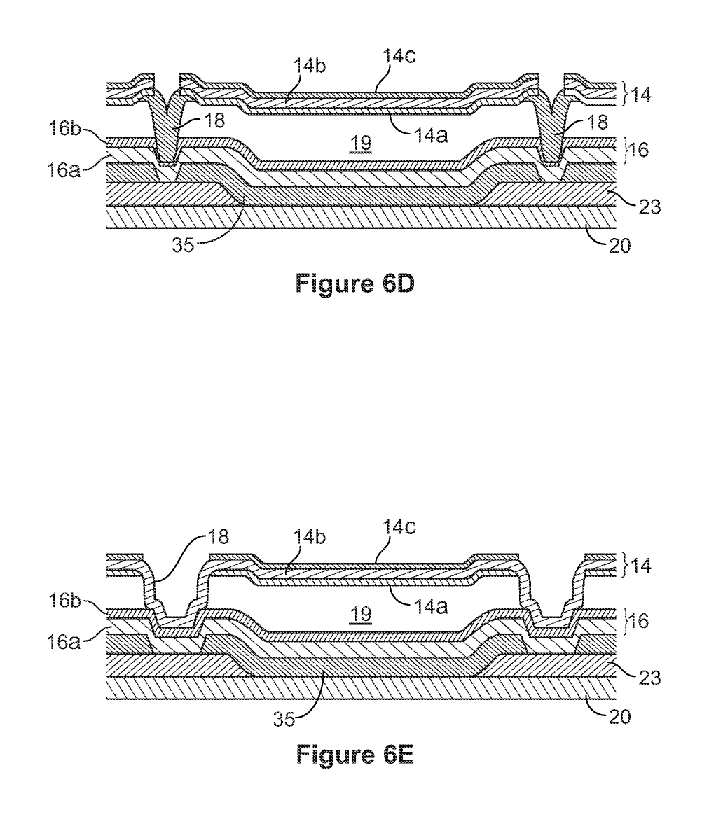

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an Al alloy with about 0.5% Cu, or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, CF₄ and/or O₂ for the MoCr and SiO₂ layers and Cl₂ and/or BCl₃ for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

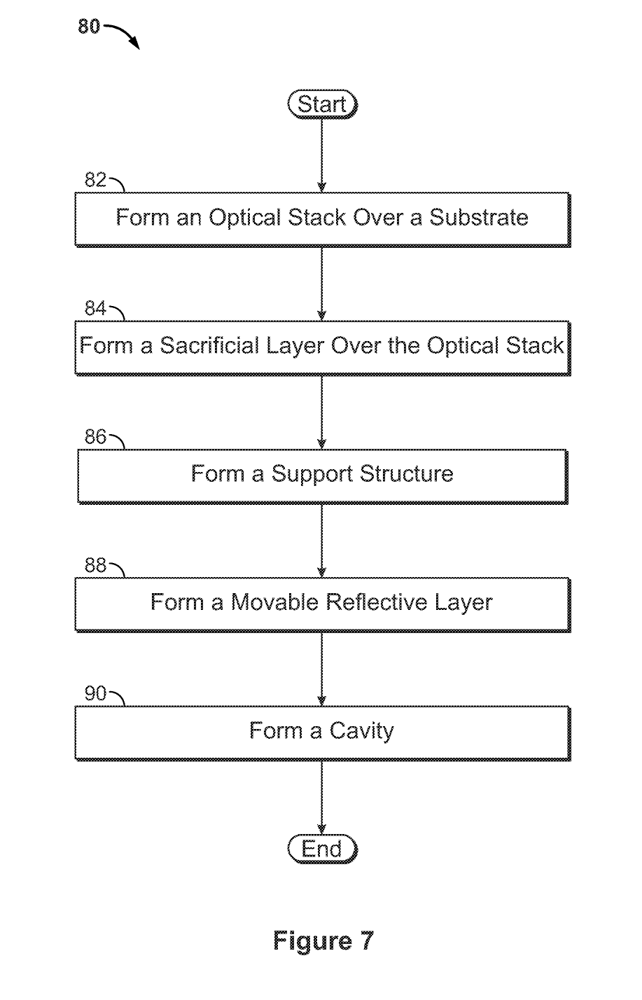

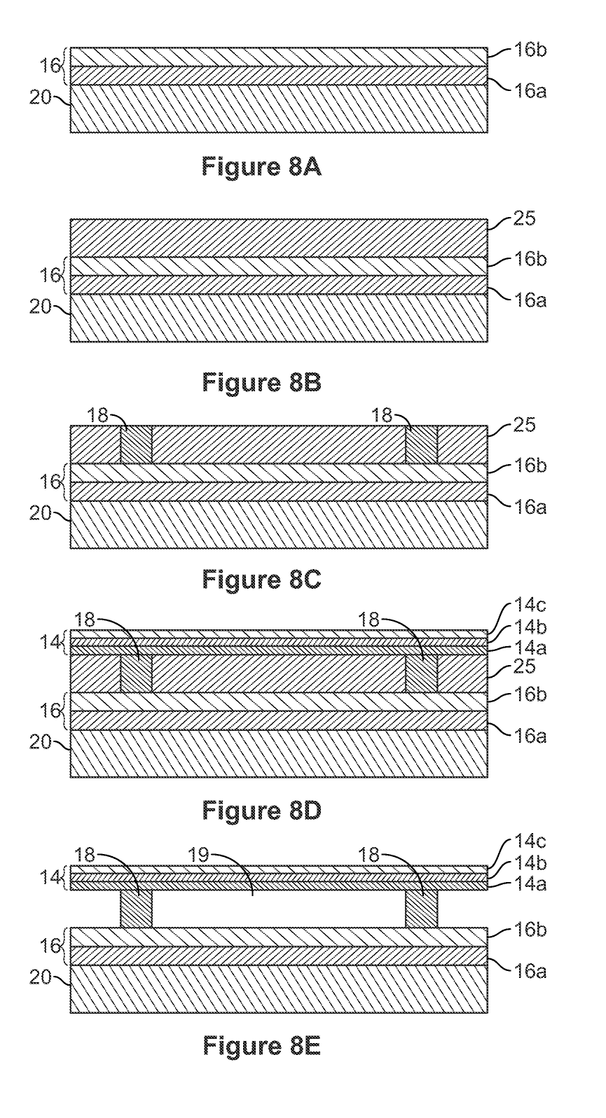

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

As described herein, the interferometric modulators may function as reflective display elements and in some implementations may use ambient lighting or internal illumination for their operation. In some of these implementations, an illumination source directs light into a light guide disposed forward of the display elements, from which light may thereafter be redirected to the display elements. The distribution of light within the light guide will determine the uniformity of the brightness of the light display elements. If light within the light guide has an uneven distribution or intensity profile, it may produce darker and brighter regions within the light guide and consequently poor illumination of the display elements when the light guide is applied to illuminate displays.

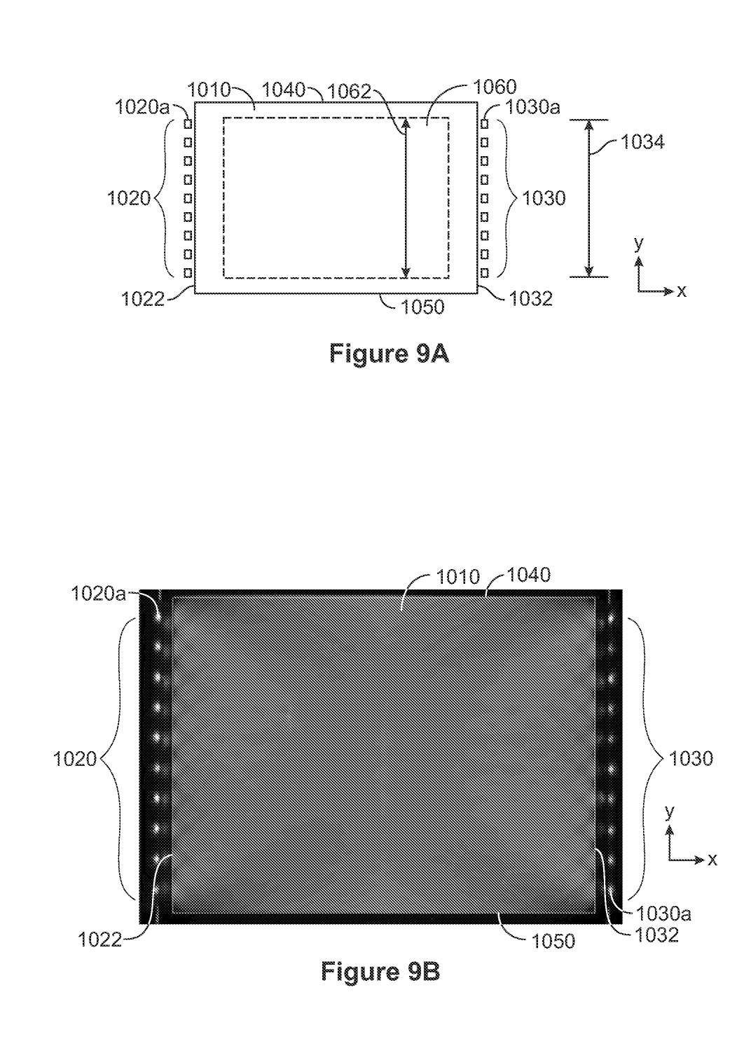

FIG. 9A shows an example of a top-down view of a light guide 1010 that can promote an uneven light distribution. Two arrays 1020 and 1030 of spaced-apart light emitters 1020a and 1030a are configured to inject light into opposite light input edges 1022 and 1032 of the light guide 1010. The light guide 1010 also has edges 1040 and 1050 that are transverse to the light input edges 1022 and 1032. The light guide 1010 and light emitter arrays 1020 and 1030 form an illumination system that can be utilized to illuminate a display (not shown). The display can have an active area in which pixels are present for forming images. The active area is represented by the numeral 1060 in FIG. 9A. Light within the light guide 1010 can be ejected out of the light guide to illuminate the active area 1060.

It has been found that the light guide 1010 can be afflicted with various non-uniformities in light distribution. FIG. 9B shows an example of a photograph of a top-down view of a light guide with an uneven light distribution. Next to the transverse edges 1040 and 1050, alternating streaks of high and low light intensity can be seen. Next to the light input edges 1022 and 1032, a cross-hatch pattern can be seen with squares of high light intensity separated by lines of low intensity. In addition, an X-shaped dark pattern can be seen extending diagonally across the light guide 1010 from the corners of the light guide. Without being limited by theory, the inventors have identified what are believed to be causes of these non-uniformities. In some implementations, these non-uniformities are reduced or eliminated.

Various possible causes of the non-uniformities are discussed initially. With continued reference to FIGS. 9A and 9B, the light guide 1010 may be formed from a larger sheet of material. The larger sheet may be cut, for example, with a diamond wheel, or by scoring and breaking off material to form the light guide 1010 having desired dimensions. It has been found that edges formed by these and similar methods can leave a rough, uneven edge having peaks and valleys.

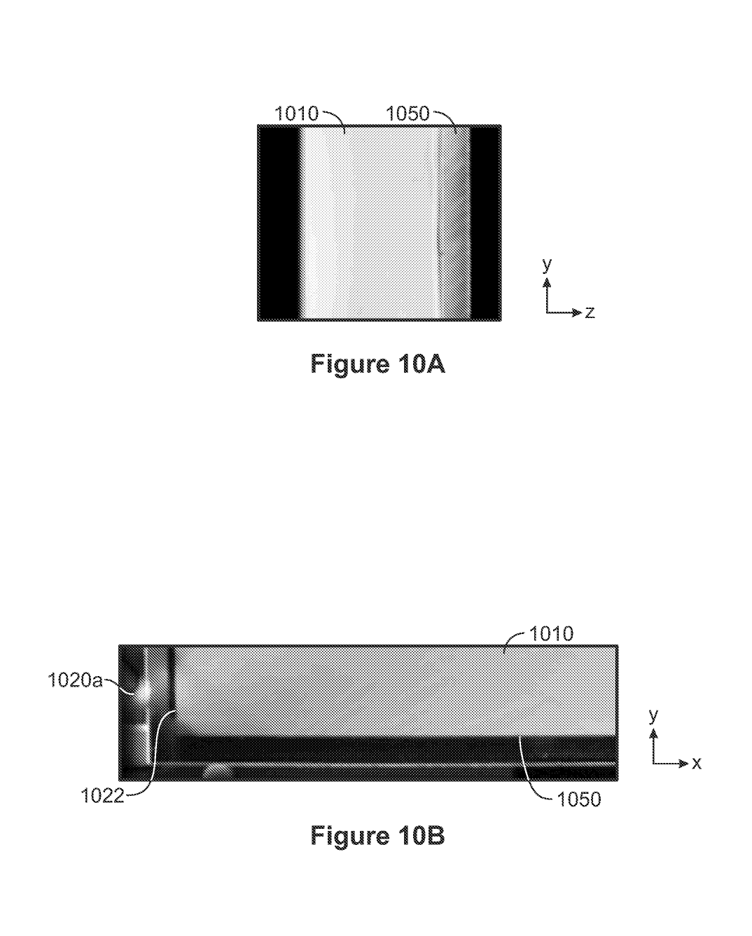

FIG. 10A shows a photograph of an example of a light guide edge formed by cutting with a diamond wheel. In particular, the transverse edge 1050 is shown. The transverse edge 1050 has peaks and valleys that define diagonal striations which are believe to be caused by the cutting motion of the cutting wheel. These striations can cause artifacts when reflecting light.

With reference to FIG. 10B, an example of a photograph of a top-down view of a section of the light guide 1010 of FIG. 10A is shown. The light emitter 1020a injects light into the light input edge 1022 of the light guide 1010. The transverse edge 1050 has peaks and valleys (FIG. 10A) that may reflect light unevenly. For example, each peak may have a side that faces the light emitter 1020a and reflects light from that light emitter, while an opposite side of the peak may be in the shadow of the peak and reflects less light. The net effect of the unevenness of the transverse edge 1050 is shown in FIG. 10B. Light injected by the light emitter 1020a propagates across light guide 1010 and contacts the transverse edge 1050. The unevenness in the transverse edge 1050 causes the light to be reflected unevenly. This non-uniform light distribution can be easily seen as streaks of reflected light defined by alternating regions of high and low light intensity.

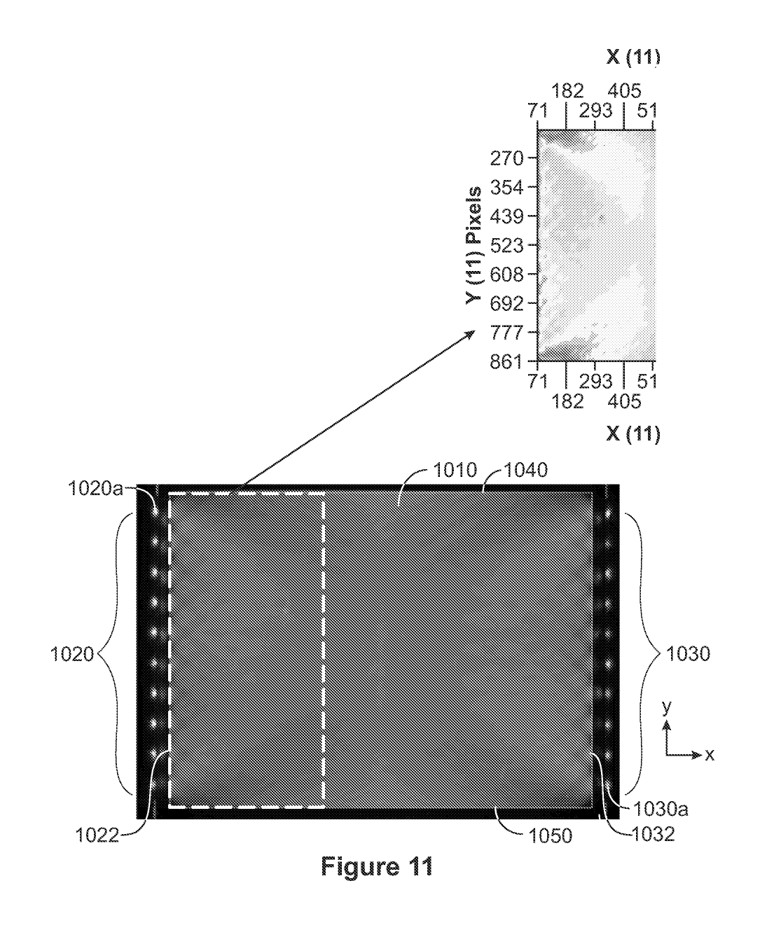

In addition to the non-uniformities caused by reflections off the transverse edge 1050, a dark X-shaped light pattern may be present across the entirety of the light guide 1010. FIG. 11 shows an example of a photograph of a top-down view of the entirety of the light guide of FIG. 10B, along with a plot of the light intensity on one side of the light guide. The tips of the “X” are at the corners of the light guide 1010. Without being limited by theory, it is believed that the X-shaped dark region is caused by the position of the light emitters 1020a and 1030a relative to the transverse edges 1040 and 1050. In some arrangements, with reference again to FIG. 9A, the light guide 1010 may be larger than the active area 1060, which has a dimension 1062 aligned with the light input edges 1032 and/or 1022. Because light from the light emitters 1020a and 1030a is used simply to illuminate the active area 1060, the light emitters 1020a and 1030a may be aligned with the corners of the active area 1060, but may not extend across a length 1034 greater than the dimension 1062. This spacing causes a dark region at the corners of the light guide 1010. It is noted that the active area 1060 may not extend to these corners of the light guide 1010. However, it has been found that the dark region is not localized only at the corners, as seen in FIG. 11. Rather, the interaction of emitted light from the light emitter arrays 1020 and 1030 with reflected light from the transverse edges 1040 and 1050 causes this dark region to extend diagonally across the light guide 1010.

In addition, with reference to FIG. 11, the light intensity next to the light input edges 1022 and 1032 may exhibit a cross-hatch pattern in which regions of high light intensity are separated by regions of low light intensity. Because the light emitters 1020a and 1030a are spaced apart and emit light with greatest intensity normal to the array of the light emitters 1020 and 1030, less light is injected into the regions of the light guide 1010 directly between the light emitters 1020a and 1030a. This contributes to the generation of the cross-hatch effect, with its alternating regions of high and low brightness. After entering the light guide 1010, light may naturally diffuse with distance from the light emitters 1020a and 1030a. As a result, the cross-hatch effect is most pronounced in regions directly adjacent the light emitters 1020a and 1030a.

Various implementations can address various of the light distribution non-uniformities discussed herein.

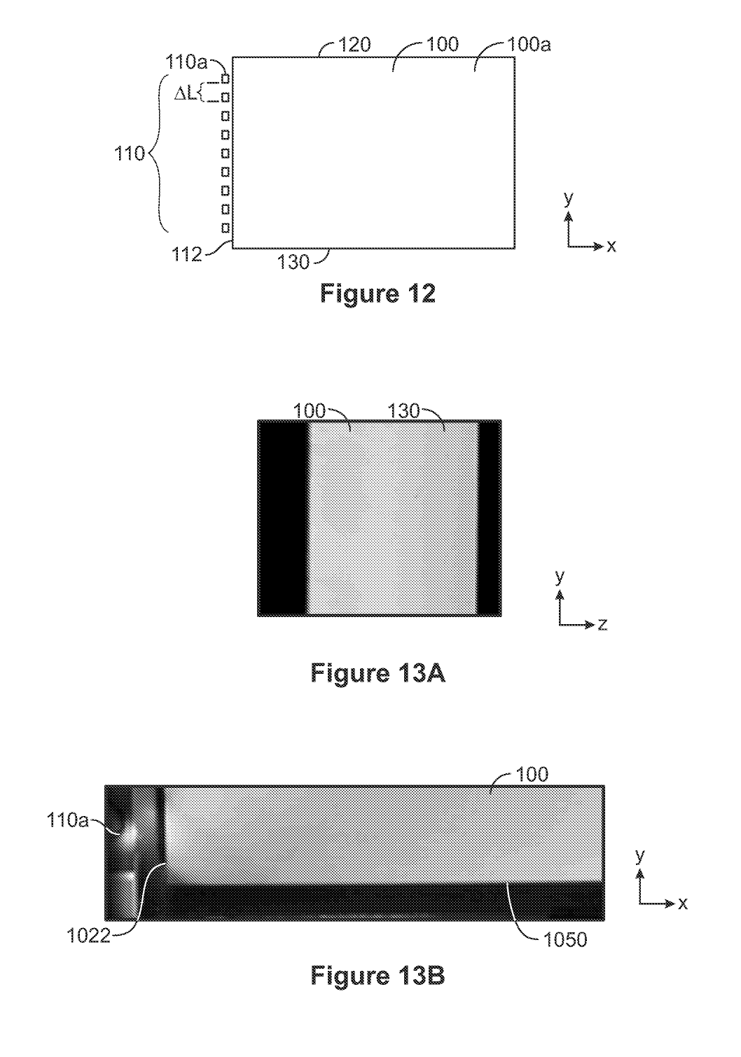

In some implementations, a light guide is provided with a smooth transverse edge that acts as a specular reflector. The specular reflector can provide specular reflection of light at visible wavelengths in some implementations and this reflection can occur by total internal reflection in some implementations. FIG. 12 shows an example of a top-down view of an illumination system having a light guide 100 with smooth transverse edges 120 and 130. Light is injected into the light guide 100 by a light emitter array 110, which includes a plurality of light emitters 110a. The light emitters 110a inject light into the light guide 100 through a light input surface 112. The light emitters 110a are uniformly spaced apart and have a pitch of ΔL. As shown in FIG. 12, the pitch of the light emitters is the distance between identical points on neighboring light emitters. Transverse edges 120 and 130 define the sides of the light guide 100 transverse to the light input surface. As illustrated, each of these edges can be planar and extend in a different plane. One or both of the transverse edges 120 and 130 are smooth and function as specular reflectors. The reflection may occur by total internal reflection (TIR) in some implementations. In some implementations, the transverse edges 120 and 130 are the longer dimension, relative to the light input edge 112, of the light guide 100. In some other implementations, the transverse edges 120 and 130 may be the shorter dimension, relative to the light input edge 112.

With continued reference to FIG. 12, the light guide 100 can be formed of one or more layers of optically transmissive material. Examples of materials include the following: acrylics, acrylate copolymers, UV-curable resins, polycarbonates, cycloolefin polymers, polymers, organic materials, inorganic materials, silicates, alumina, sapphire, polyethylene terephthalate (PET), polyethylene terephthalate glycol (PET-G), silicon oxy-nitride, and/or other optically transmissive materials. In some implementations, the optically transmissive material is a glass.

The light emitters 110a may be a light emitting device such as, but not limited to, a light emitting diode (LED), an incandescent bulb, a laser, a fluorescent tube, or any other form of light emitter. In some other implementations, a single light emitter 110a in the form of a light bar which extends along the majority of the light input edge 112. In certain implementations, light from the light emitters 110a is injected into the light guide 100 such that a portion of the light propagates in a direction across at least a portion of the light guide 100 at a low-graze angle relative to a major surface 100a of the light guide 100 such that the light is reflected within the light guide 100 by total internal reflection (TIR).

With continued reference to FIG. 12, the transverse edges 120 and/or 130 may be formed by a process that results in a smooth surface. In some implementations, the surface of the transverse edges 120 and/or 130 is smooth and may function as a specular reflector. The smooth surface may be formed as the transverse edges 120 and/or 130 are defined, or may be formed by processing after defining the edges 120 and/or 130. For example, the transverse edges 120 and/or 130 may be laser-cut edges defined by laser cutting, in which a laser cuts completely through a material (for example, by melting the material) to form that edge. In some other implementations, the transverse edges 120 and/or 130 maybe formed by any method, such as cutting with a cutting wheel or scoring and breaking a piece of material, which may leave a rough or uneven surface. The rough or uneven surface may then be subjected to a smoothing process, such as grinding or abrasion with a fine grit and/or polishing the surface.

The transverse edges 120 and/or 130 provide specular reflection over continuous lengths of the transverse edges of about 0.1 mm or more, about 0.5 mm or more, about 1 mm or more, about 5 mm or more, or about 10 mm or more in some implementations. Such levels of specular reflection may be present over the entirety of a transverse edge. In some implementations, the transverse edges 120 and/or 130 function as specular reflectors over substantially the entirety of both their lengths.

In some implementations, the transverse edges may function as specular reflectors while having minor deviations from completely undistorted reflection (of visible light) along the length of a transverse edge. For example, over lengths of 1 cm across a length of a transverse edge, these deviations in aggregate may cover distances of no more than about 1 mm, no more than about 0.05 mm, no more than about 0.03 mm, no more than about 0.02 mm, or no more than about 0.01 mm. In some implementations, the widths of individual light streaks caused by deviations from completely undistorted reflection are no more than about 1 mm, no more than about 0.05 mm, no more than about 0.03 mm, no more than about 0.02 mm, or no more than about 0.01 mm.

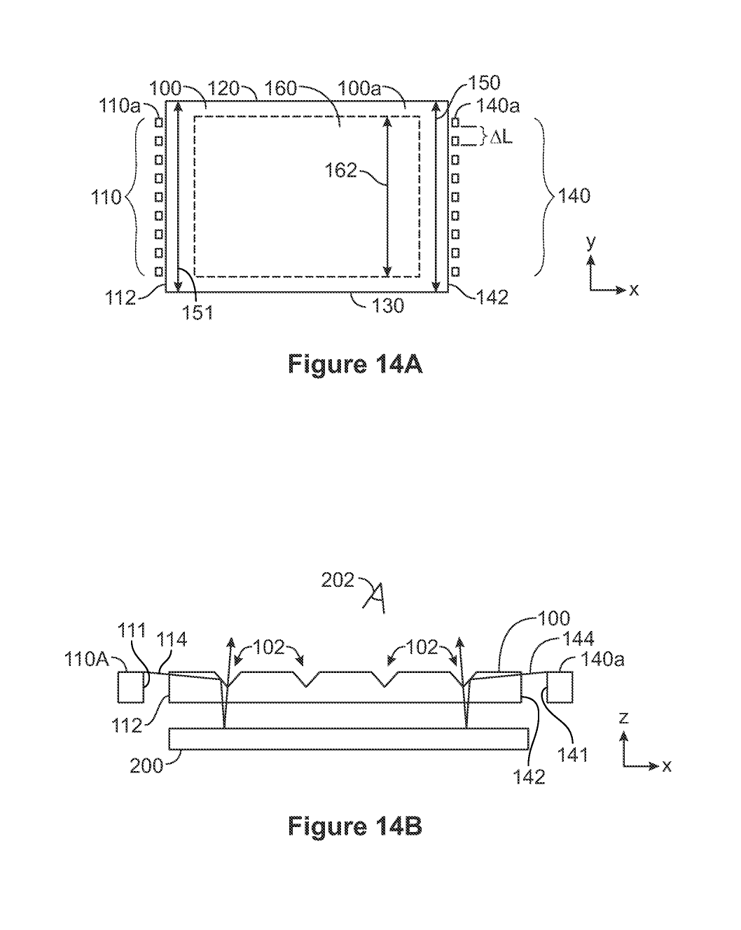

The transverse edges providing specular reflection may have a smooth appearance. FIG. 13A shows an example of a photograph of an edge of a light guide formed by laser-cutting. The transverse edge 130 of the light guide 100 is exceptionally smooth, as evidenced by the uniform appearance of that edge.

The transverse edge 130 functions as a specular reflector to reduce reflection artifacts caused by an uneven surface. FIG. 13B shows an example of a photograph of a top down view of a section of the light guide 100 also shown in FIG. 13A. Light from the light emitter 110a is injected into the light guide 100 through the light input surface 112. The light propagates through the light guide 100 and impinges on the transverse edge 130, where it is reflected. The transverse edge 130 acts a specular reflector and the reflected light intensity is highly uniform, with the degree of uniformity determined by the uniformity of the light impinging on the transverse edge 130. In some implementations, the uniformity of the reflected light substantially matches the uniformity of light impinging on the transverse edge 130. In comparison with the uneven edge 1050 shown in FIG. 10B, artifacts caused by reflection off the transverse edge 130 are not observed. Streaks of high and low intensity light are not apparent. Thus, the smooth transverse edge 130 reduces or eliminates artifacts and non-uniformities in light distribution caused by reflection off an uneven surface.

In addition, it is believed that the transverse edge 130 can also increase uniformity by providing “virtual” light emitters along that edge. The light emitters 110a of the array 110 are spaced apart and the image of those light emitters is reflected at different locations along the transverse edges 120 and/or 130 (FIG. 12). One of ordinary skill in the art will recognize that light propagates from each of those reflected images and, as such, the reflected images function as spaced-apart “virtual” light emitters themselves. This can have the affect of increasing the apparent number of light emitters around the light guide, thereby improving the uniformity of light distribution within the light guide 100.

With reference to FIG. 14A, actual light emitters can be positioned at multiple sides of the light guide 100. FIG. 14A shows an example of a light guide 100 having multiple light emitter arrays. The array 110 is at the light input edge 112 and a second array 140 of light emitters 140a is at an opposing light input edge 142. The light emitters 140a have a pitch ΔL, which can be the same value as the separation between neighboring ones of the light emitters 110a, or may be a different value (for example, if the number of light emitters on each side of the light guide 100 are different, then the separation between light emitters on each side may be different). The transverse edges 120 and 130 may each extend along a line between the edges 112 and 142. The transverse edges 120 and 130 may be spaced apart by a distance 150, which may also be the length of the edges 112 and 142 in some implementations, or may be longer than the length of the edges 112 and 142 in implementations in which the corners of the light guide 100 are rounded or taper towards the edges 112 and 142. In some other implementations, the lengths of the light input edges 112 and 142 may be different.

It has been found that the spacing and placement of the light emitters 110a and 140a can impact the uniformity of the light distribution within the light guide 100. With reference to FIG. 14B, the light guide 100 may be used to illuminate a display 200. FIG. 14B shows an example of a side cross-section of a display system incorporating the light guide 100 of FIG. 14A. As illustrated, the display 200 may be provided below the light guide 100. In such implementations, the light guide 100 is part of a front light and is positioned forward of the display 200, closer to a viewer 202 than the display 200. The light guide 100 can be provided with a plurality of light turning features 102 that turn light propagating inside the light guide 100 so that the light is directed out of the light guide 100 towards the display 200. The light turning features 102 may be, without limitation, prismatic reflective features, diffractive features (for example, holographic features or diffractive gratings), or combinations thereof.

As illustrated, light rays 114 and 144 from the light emitters 110a and 140a, respectively, can be injected into the light guide 100, propagate through the light guide 100 and then be ejected out of a major surface of the light guide 100 by the light turning features 102. The ejected light rays 114 and 144 illuminate the underlying display 200, which can be a reflective display that reflects the light back through the light guide 100 towards the viewer 202. The display 200 can have reflective display elements such as interferometric modulators 12 (FIG. 1). In other implementations, the light guide 100 may be positioned behind the display 200 and be part of a backlight. In such implementations, the display 200 may be a transmissive display, such as a liquid crystal display.

With continued reference to FIG. 14B, the light emitters 110a and 140a each have a face 111 and 141, respectively, out of which light is emitted. The faces 111 and 141 each have a height extending in the same axis as the thickness dimension of the light guide 100, or the width of the light input edge 142. In some implementations, the heights of the faces 111 and 141 are about equal to or greater than the width of the light input edge 142, or the thickness of the light guide 100.

With reference to both FIGS. 14A and 14B, the pixels of the display 200 can occupy an area referred to as the active area. The active area is the part of the display 200 in which an image is displayed to the viewer 202. In some implementations, with reference to FIG. 14A, the active area, represented by reference numeral 160, is smaller than the area occupied by the major surface 100a of the light guide 100. For example, the active area 160 may have a dimension 162 which is aligned with and directly faces the light input edge 142. In addition, the dimension 162 may be smaller than the distance 150 separating the transverse edges 120 and 130. As noted herein, it has been believed that the pitch of the light emitters 110a and 140a and the distance covered by the arrays 110 and 140 should be chosen based upon the dimensions of the active area 160. For example, it has been believed that the positions of the light emitters 140a should be chosen based upon the dimension 162 of the active area 160 aligned with and closest to the light guide edge 142, since it is the active area 160 that is illuminated and propagating light through the whole of the light guide 100 would be unnecessary for illuminating the active area 160. It has been found, however, that such a design rule causes an X-shaped light pattern across the light guide 100 (FIG. 11).

In some implementations, rather than basing the parameters of the spacing of the light emitters 110a and 140a and the distance covered by the arrays 110 and 140 on the dimensions of the active area 162, these parameters are determined by the distance 150 between the reflective transverse edges 120 and 130. For example, for the array 140 and light emitters 140a, the pitch of the light emitters is determined by the distance 150. In some implementations, the distance between the light emitters 140a and the nearest transverse edge 120 or 130 is no more than half the pitch of the light emitters 140a. In some implementations, the arrays 110 and 140 are centered along a corresponding light input edge 112 and 142, respectively, and the light emitters 110a and 140a have a pitch ΔL determined by the following formula:

$$Δ L = \frac{{L}_{light guide}}{{N}_{light emitters}}$$

where
ΔL is a distance between identical points of neighboring light emitters;
L_{light guide} is the distance between the transverse edges of the light guide; and
N_{light emitters} is the number of light emitters in the array of light emitters.

Positioning the light emitters with pitch ΔL and centering the light emitter arrays along the light input edges can result in the light emitters extending beyond the active area, such that a light emitter array covers a greater distance than the active area dimension 162. In some implementations, L_{light guide} is the distance between the transverse edges of the light guide at the light input edge along which the pitch ΔL is being calculated.

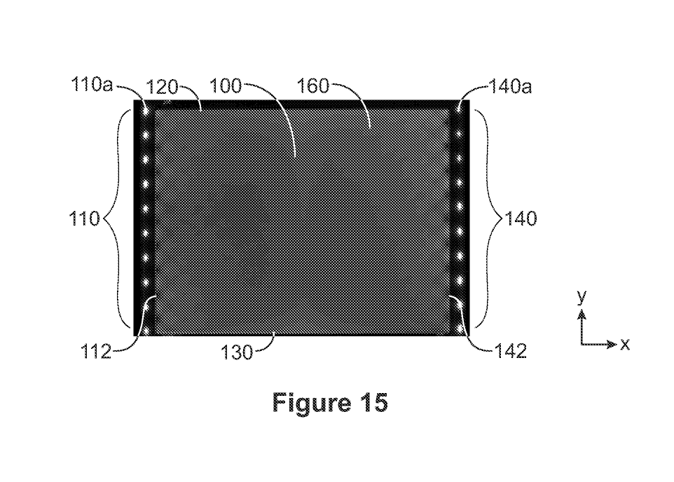

FIG. 15 is an example of a photograph of top-down view of a light guide having light emitters spaced in accordance with some implementations. The arrays 110 and 140 are centered along their corresponding light input edges 112 and 142 and the light emitters 110a and 140a are spaced according to the formula above for ΔL. It can be seen that the X-shaped pattern of FIG. 11, in which light emitter position was selected based upon active area dimensions, has been substantially eliminated. In addition, the light guide 100 of FIG. 15 has smooth transverse edges 120 and 130. As seen in the photograph, the light distribution adjacent to those edges is also highly uniform.

In some implementations, the transverse edges 120 and/or 130 can preserve the intensity profile of the light striking those edges, such that the intensity profile of the light reflecting off a length of a transverse edge substantially matches the intensity profile of the light striking that edge. For example, the intensity of the reflected light at any given point along a length of a transverse edge may have differences of no more than about 5%, no more than about 2%, or no more than about 1% from the intensity of the light striking the edge at that point.

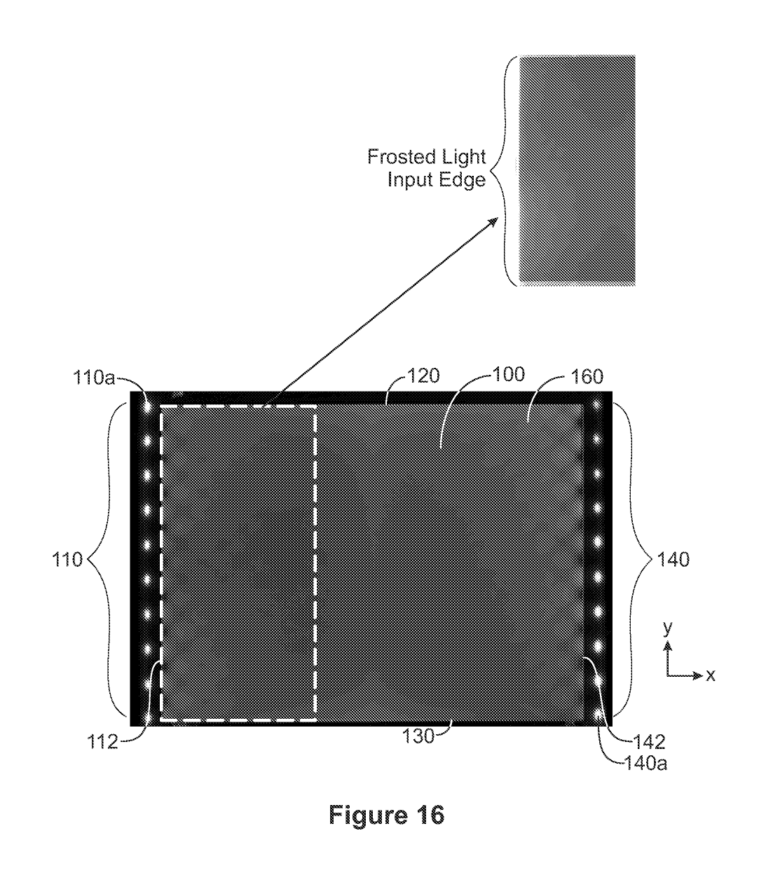

With continued reference to FIG. 15, a cross-hatch pattern may be still be observed near the light input edges 112 and 142. With reference to FIG. 16, examples of photographs showing a light guide without and with optically diffusive light input edges are shown. It has been found that the cross-hatch pattern can be reduced or eliminated by treating the light input edges 112 and/or 142 to form an optically diffusive surface. Treating the light input edge may involve changing the physical structure or topology of the light input surface itself, for example, roughening the surface, and/or adding an additional structure to that surface, including a light diffusive coating or layer of material, or an adhered light diffusive structure.

The roughened surface of a light input edge may also be referred to as a frosted surface. In some implementations, the light input edges 112 and/or 142 may be subjected to abrasion or other processing to remove material from one or more of those edges, thereby forming a frosted surface. Examples of processes to abrade the light input surface 122 include rubbing the surface with sand paper or other material with abrasive particles, projecting abrasive particles onto the light input surface, chemical etching the light input surface, and combinations thereof.

In some implementations, sanding of the light input surface 122 can be accomplished using a sanding implement, for example sand paper, having a grit number of about 220 or more, about 280-600, about 280-500, or about 360-400. In some applications, grit numbers of about 280-500, or about 360-400, provide particular advantages for reducing the cross-hatch effect while retaining high levels of brightness. In some implementations, the frosted surface 140 has a surface roughness Ra of about 0.5-3 μm, about 0.7-2 μm, about 0.8-1.5 μm, or about 0.8-1.2 μm. In some applications, a surface roughness Ra of about 0.8-1.5 μm, or about 0.8-1.2 μm allows reductions in the cross-hatch effect while providing an illumination device with excellent brightness levels. In some implementations, relative to not having the frosted surface present, the reduction in brightness is less than about 20%, or less than about 10%.

With continued reference to FIG. 16, the photograph on the lower left hand side is identical to the photograph of FIG. 15 and shows the cross-hatch pattern. The photograph on the upper right hand corner of FIG. 16 shows a section of an otherwise identical light guide 100 in which the light input surface 112 has been treated to form a frosted surface. It can be seen that the cross-hatch pattern has been substantially eliminated and a relatively uniform light intensity profile is achieved. In addition, the X-shaped pattern, and light streaks caused by uneven transverse edges are also substantially eliminated, as discussed herein.

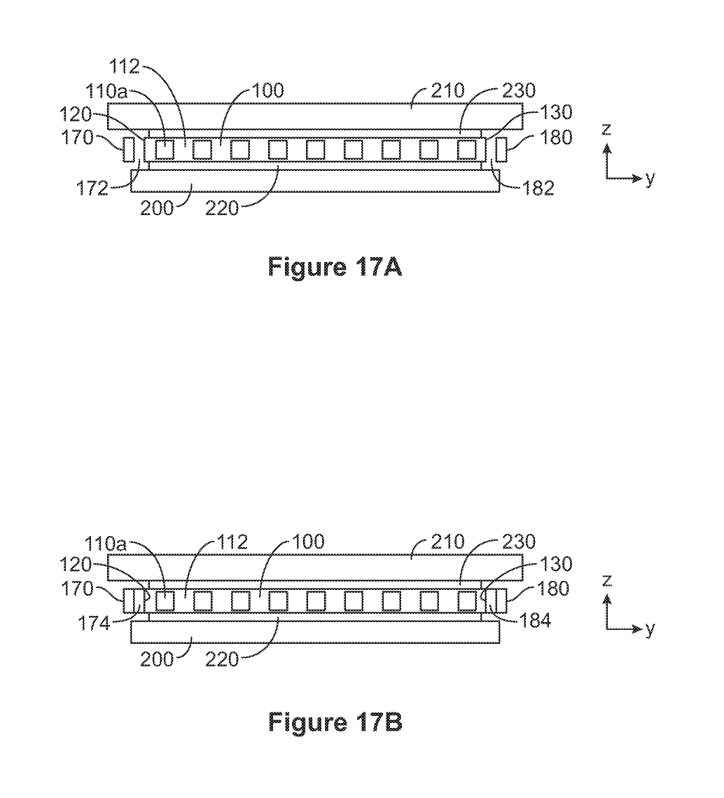

With reference to FIGS. 17A and 17B, in some implementations, the transverse edges 120 and 130 can be provided with auxiliary reflectors 170 and 180, respectively. FIG. 17A shows an example of a side view of a display system with auxiliary reflectors spaced apart from a light guide by an air gap. FIG. 17B shows an example of a side view of a display system with auxiliary reflectors spaced apart from a light guide by a layer of solid material, for example, an adhesive.

Because reflections at the transverse edges 120 and 130 occur by total internal reflection, light impinging on those edges at angles less than the critical angle will not be reflected and could be lost when they propagate out of the light guide. To recapture this light, one or both of the auxiliary reflectors 170 and 180 can be provided to reflect light that escapes the light guide 100 back into the light guide. The auxiliary reflectors 170 and 180 may be specular reflectors and may take various forms, including a metallized film, metal sheet (for example, a stamped metal sheet), and a dielectric stack film (ESR).

To facilitate TIR at the transverse edges 120 and 130, air gaps 172 and 182 may by provided between the auxiliary reflectors 170 and 180 and the corresponding transverse edges 120 and 130, as shown in FIG. 17A. The air gaps 172 and 182 provide a low refractive index medium, relative to the higher refractive index material of the light guide 100, thereby facilitating TIR at the transverse edges 120 and 130.

With reference to FIG. 17B, layers of solid material 174 and 184 may be disposed between the transverse edges 120 and 130 and the auxiliary reflectors 170 and 180. In some implementations, the layers 174 and 184 may be adhesive layers that adhere the auxiliary reflectors 170 and 180 to their respective transverse edges 120 and 130. The layers 174 and 184 may have a lower refractive index than the light guide 100 to facilitate TIR. In some implementations, the refractive index of the layers 174 and 184 may be lower than the refractive index of the light guide 100 by about 0.05 or more, or about 0.10 or more.

In some other implementations, the layers 174 and 184 are index-matched to or have a higher refractive index than the light guide 100. In such implementations, TIR may not occur at the transverse edges 120 and 130. Rather, the light propagates out of the light guide 100 and is reflected upon impinging on the auxiliary reflectors 170 and 180. Because light is not reflected by the transverse edges 120 and 130 in these implementations, the transverse edges 120 and 130 may be uneven and may not be smooth. Rather, the auxiliary reflectors 170 and 180 may act as the sole specular reflectors along the transverse edges 120 and 130 in some implementations.

In some other implementations, the auxiliary reflectors 170 and 180 are not spaced apart from the transverse edges 120 and 130. Rather, the auxiliary reflectors 170 and 180 are disposed directly on those edges 120 and 130. For example, the auxiliary reflectors 170 and 180 may be a metallization layer deposited directly on the edges 120 and 130.

With continued reference to FIGS. 17A and 17B, illumination systems having the light guide 100 and the light emitters 110a and 142a can be integrated into display systems to illuminate displays. For example, the illumination systems can be integrated in a stack with the display 200. Where the illumination system is a front light, the stack can also include a superstrate 210 that overlies the light guide 100. The superstrate 210 can be a functional structure provides various functions and can include, for example, an antiglare layer, a scratch resistant layer, an antifingerprint layer, a touch panel, an optical filtering layer, a light diffusion layer, and combinations thereof. One or more layers of material can be between the light guide 100 and the display 200 and the superstrate 210. For example, a layer 220 can separate the display 200 and the light guide 100, and a layer 230 can separate the superstrate 210 and the light guide 100. In some implementations, the layers 220 and/or 230 are adhesive layers. In some implementations, the layers 220 and/or 230 are cladding layers which have a lower refractive index than the light guide 100. The lower refractive index facilitates TIR within the light guide 100, thereby promoting the propagation of light across the light guide 100. In some implementations, the refractive index of the layers 220 and 230 may be lower than the refractive index of the light guide 100 by about 0.05 or more, or about 0.10 or more. In some other implementations, the display 200 and the superstrate 210 themselves provide layers of material that act as cladding layers and have refractive indices that are lower than the refractive index of the light guide 100 by about 0.05 or more, or about 0.10 or more.

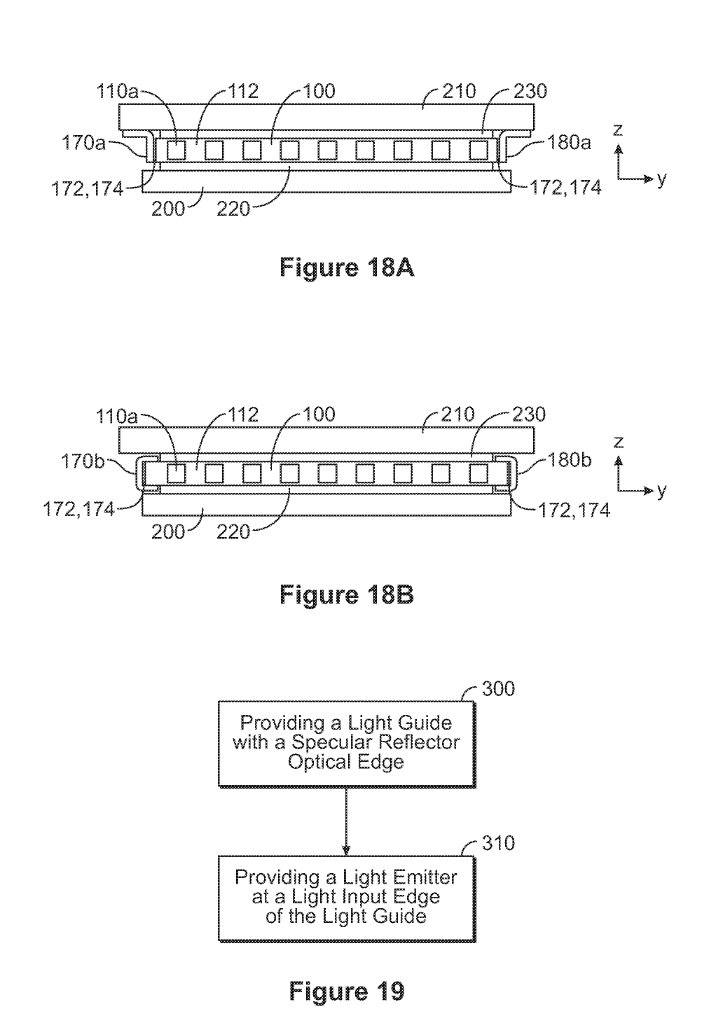

With reference to FIGS. 18A and 18B, the various other structures in a display system stack can provide surfaces for attaching the auxiliary reflectors 170 and 180. For example, the auxiliary reflectors 170 and 180 may be attached to a structure, such as the superstrate 210, that protrudes beyond the light guide 100. FIG. 18A shows an example of a cross-section of a display system with an auxiliary reflector attached to a superstrate. In some other implementations, the auxiliary reflectors 170 and 180 are attached to the light guide 100 itself. FIG. 18B shows an example of a cross-section of a display system with an auxiliary reflector attached to a light guide.

With reference now to FIG. 19, a block diagram depicting an example of a method of manufacturing an illumination system is shown. A light guide having an optical edge that is a specular reflector is provided 300. A light emitter is provided 310 at a light input edge of the light guide. The optical edge can be an edge of the light guide transverse to the light input edge. The optical edge may provide specular reflection over a continuous distance of at least about 5 mm along the transverse edges.

The optical edge can be formed by various processes, including laser-cutting, and forming a light guide edge with an uneven surface and then smoothing the surface (for example, by grinding and/or polishing the edge). The uneven surface may be formed by, for example, cutting with a cutting wheel or scoring and breaking a piece of material.

In some implementations, the specular reflector is provided by attaching a specular reflector adjacent to a transverse edge of the light guide. The attachment may be made by adhering the specular reflector directly to the transverse edge. In some other implementations, an air gap separates the specular reflector from the transverse edge.

Providing the light emitter may include attaching the light emitter adjacent to the light input edge. Attaching the light emitter can include attaching a plurality of light emitters centered along the light input edge. The light emitters can be spaced apart with a pitch of about ΔL, where

$$Δ L = \frac{{L}_{light guide}}{{N}_{light emitters}}$$

where
ΔL is a distance between identical points of neighboring light emitters;
L_{light guide} is the distance between the transverse edges of the light guide; and
N_{light emitters} is the number of light emitters in the array of light emitters.

The light emitters may be attached to the light guide by various methods, including chemically attaching the light source to the light guide (for example, by adhesion) or mechanically attaching the light source using fasteners.

The light input edge may be roughened to form an optically diffusive surface. The roughening may occurs by various methods disclosed herein, including abrasion by contact with abrasive particles, such as those on sand paper. The direction of the particle movement may proceed in various directions. In some implementations, the abrasive particle movement is substantially in the direction of the short dimension of the light input edge (for example, in the direction of the thickness dimension of the light guide), which can give a more uniform light dispersion than particle movement along the long dimension of the light input edge.

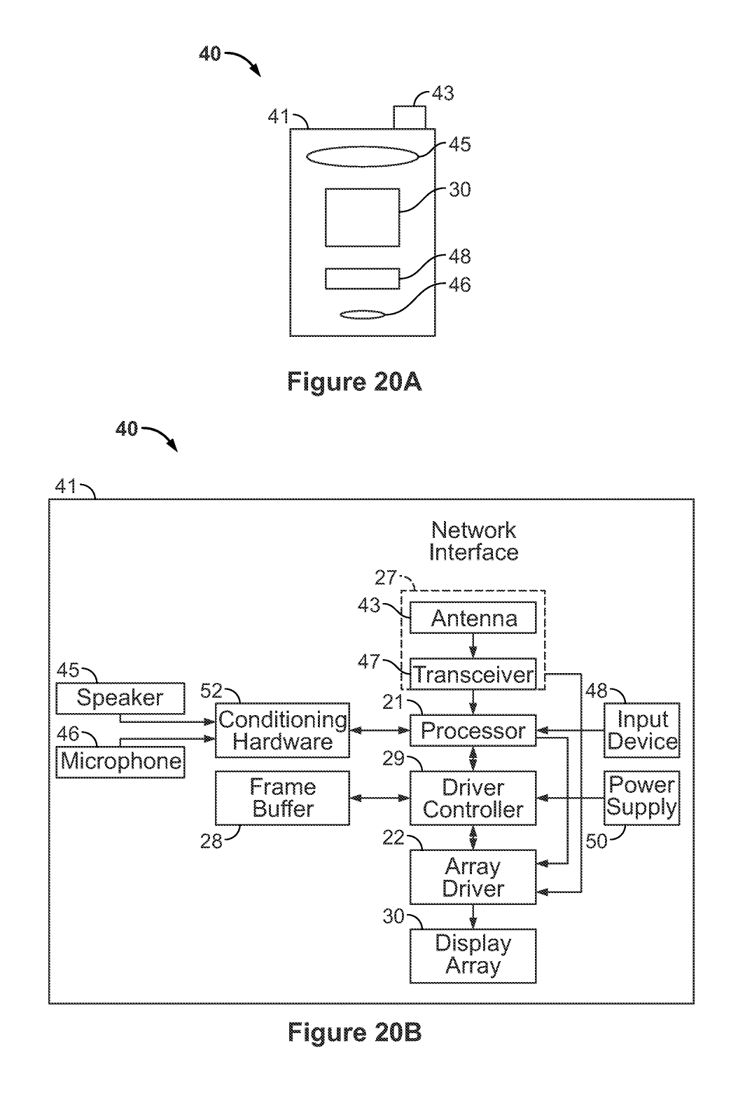

FIGS. 20A and 20B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 21B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An illumination system, comprising:
a plurality of light emitters; and
a light guide, including:
a light input edge for receiving light from the plurality of light emitters; and
a first laser-cut edge transverse to the light input edge.

2. The illumination system of claim 1, wherein the light guide is formed of glass.

3. The illumination system of claim 1, wherein the light input edge is frosted.

4. The illumination system of claim 3, wherein the light input edge has a surface roughness Ra of about 0.1-5 μm.

5. The illumination system of claim 4, wherein the light emitters have a pitch of about ΔL, wherein
$$Δ L = \frac{{L}_{light guide}}{{N}_{light emitters}}$$
where
ΔL is a distance between identical points of neighboring light emitters;
L_{light guide} is the distance between the transverse edges of the light guide; and
N_{light emitters} is the number of light emitters in the plurality of light emitters.

6. The illumination system of claim 5, further comprising a display having an active display area smaller than an area of the light guide, wherein the length of the light input edge is larger than a corresponding dimension of the active display area facing the light input edge.

7. The illumination system of claim 1, further comprising a display having a major surface facing the major surface of the light guide, wherein the light guide comprises a plurality of light turning features configured to eject light out of the light guide and towards the major surface of the light guide.

8. The illumination system of claim 17, wherein the light guide forms part of a front light.

9. The illumination system of claim 17, wherein the display is a reflective display including an array of inteferometric modulators.

10. The illumination system of claim 17, further comprising:
a processor that is configured to communicate with the display, the processor being configured to process image data; and
a memory device that is configured to communicate with the processor.

11. The illumination system of claim 10, further comprising:
a driver circuit configured to send at least one signal to the display.

12. The illumination system of claim 11, further comprising:
a controller configured to send at least a portion of the image data to the driver circuit.

13. The illumination system of claim 10, further comprising:
an image source module configured to send the image data to the processor.

14. The illumination system of claim 13, wherein the image source module includes at least one of a receiver, transceiver, and transmitter.

15. The illumination system of claim 10, further comprising:
an input device configured to receive input data and to communicate the input data to the processor.

16. The illumination system of claim 1, further comprising a second laser-cut edge opposite the first laser-cut edge and transverse to the light input edge.

17. The illumination system of claim 1, wherein the light guide is a generally planar plate of optically transmissive material.

18. An illumination system, comprising:
a light emitter;
a light guide formed of glass, the light guide including:
a light input edge for receiving light from the light emitter; and
a transverse edge transverse to the light input edge, and
a specular reflector along the transverse edge.

19. The illumination system of claim 18, wherein the light input edge is frosted.

20. The illumination system of claim 18, wherein the specular reflector extends substantially an entire length of the transverse edge.

21. The illumination system of claim 18, wherein the specular reflector is a surface of the transverse edge.

22. The illumination system of claim 21, further comprising an auxiliary reflector adjacent to the transverse edge and configured to reflect light exiting the transverse edge back into the light guide.

23. The illumination system of claim 22, wherein the auxiliary reflector is spaced apart from the transverse edge.

24. The illumination system of claim 18, wherein the specular reflector is attached to the light guide.

25. The illumination system of claim 18, further comprising a plurality of light emitters, wherein the light emitters are uniformly spaced apart by a distance of about ΔL, wherein
$$Δ L = \frac{{L}_{light guide}}{{N}_{light emitters}}$$
where
ΔL is a distance between identical points of neighboring light emitters;
L_{light guide} is the distance between the transverse edges of the light guide; and
N_{light emitters} is the number of light emitters in the plurality of light emitters.

26. The illumination system of claim 18, further comprising a display having a major surface facing the major surface of the light guide, wherein the light guide comprises a plurality of light turning features configured to eject light out of the light guide and towards the major surface of the light guide.

27. The display system of claim 26, further comprising a superstrate forward of the light guide, the superstrate including a structure selected from the group consisting of an antiglare layer, a scratch resistant layer, an antifingerprint layer, a touch panel, an optical filtering layer, a light diffusion layer, and combinations thereof.

28. The display system of claim 1, wherein the light guide is disposed between the superstrate and the display, and further comprising an optical cladding layer disposed between the light guide and one or both of the superstrate and the display.

29. The illumination system of claim 18, wherein the first specular reflection surface provides specular reflection over continuous lengths of the first transverse edge, the lengths being about 5 mm or more.

30. A display system, comprising:
a light guide, including:
a light input edge for receiving light, the light input edge having a length; and
a first transverse edge, the first transverse edge transverse to the light input edge;
a first specular reflection surface along the first transverse edge;
a display having an active area, wherein a major surface of the display faces a major surface of the light guide and the length of the light input edge is larger than a corresponding dimension of the pixel area facing the length; and
a plurality of spaced-apart light emitters configured to inject light into the light input edge,
wherein a spacing between the light emitters is about ΔL, wherein
$$Δ L = \frac{{L}_{light guide}}{{N}_{light emitters}}$$
where
ΔL is a distance between identical points of neighboring light emitters;
L_{light guide} is the distance separating the transverse edges of the light guide; and
N_{light emitters} is the number of light emitters in the plurality of light emitters.

31. The display system of claim 30, wherein each of the light emitters have a light emitting face with a height extending substantially on a same axis as a width of the light input edge, wherein the height of the light emitting face is greater than or equal to the width of the light input edge.

32. The display system of claim 30, wherein the first specular reflection surface is a surface of the first transverse edge.

33. The display system of claim 30, further comprising:
a second specular reflection surface along a second transverse edge transverse to the light input edge and opposite the first transverse edge;
another light input edge on a side of the light guide opposite the light input edge; and
another plurality of light emitters configured to inject light into the other light input edge,
wherein a spacing between the light emitters is about ΔL, wherein
$$Δ {L}^{′} = \frac{{L}_{light guide}^{′}}{{N}_{light emitters}^{′}}$$
where
ΔL is a distance between identical points of neighboring light emitters;
L_{light guide} is the distance separating the transverse edges of the light guide; and
N_{light emitters} is the number of light emitters in the plurality of light emitters.

34. The display system of claim 30, wherein the plurality of light emitters is centered along the light input edge.

35. The display system of claim 30, wherein the light guide is forward of the display and is part of a front light, wherein the display is a reflective display.

36. An illumination system, comprising:
a light source;
a light guide having a light input edge configured to receive light from the light emitters and opposing transverse edges transverse to the light input edge; and
means for reflecting light along at least one of the transverse edges.

37. The illumination system of claim 36, wherein the light source includes a plurality of light emitters configured to inject light into the light guiding means.

38. The illumination system of claim 37, wherein the light guide is formed of glass.

39. The illumination system of claim 37, wherein the means for reflecting light is a surface of at least one of the transverse edges.

40. The illumination system of claim 39, wherein the surface provides specular reflection over a continuous distance of at least about 5 mm along the at least one of the transverse edges.

41. The illumination system of claim 37, wherein the means for reflecting light includes a specular reflector spaced apart from the transverse edge.

42. The illumination system of claim 37, wherein the light input edge includes a frosted surface.

43. A method for manufacturing an illumination system, comprising:
providing a light guide having an optical edge that is a specular reflector, the specular reflector providing specular reflection over continuous lengths of the first transverse edge, the lengths being about 5 mm or more; and
providing a light emitter at a light input edge of the light guide,
wherein the optical edge is transverse to the light input edge.

44. The method of claim 43, wherein providing the light guide includes laser-cutting an optically transmissive material to form the specular reflector at the edge of the light guide.

45. The method of claim 44, wherein the optically transmissive material is glass.

46. The method of claim 43, wherein providing the light guide includes grinding and polishing the optical edge.

47. The method of claim 43, wherein providing the light guide includes attaching the specular reflector adjacent to an edge of the light guide transverse to the light input edge.

48. The method of claim 47, wherein attaching the specular reflector leaves the specular reflector spaced apart from the edge of the light guide transverse to the light input edge.

49. The method of claim 43, wherein providing the light emitter includes providing a plurality of the light emitters centered along the light input edge, wherein a pitch of the light emitters is about ΔL, wherein
$$Δ L = \frac{{L}_{light guide}}{{N}_{light emitters}}$$
where
ΔL is a distance between identical points of neighboring light emitters;
L_{light guide} is the distance between the transverse edges of the light guide; and
N_{light emitters} is the number of light emitters in the plurality of light emitters.

50. The method of claim 43, wherein providing the light guide includes roughening the light input edge to form an optically diffusive surface on the light input edge.
